(19) United States
(12) Patent Application Publication
(10) Pub. No.: US 2017/0090887 A1
(43) Pub. Date: Mar. 30, 2017

(54) PROGRAMMING LANGUAGE PROCESSING PROGRAM, PROGRAMMING LANGUAGE PROCESSING DEVICE, AND PROGRAMMING LANGUAGE PROCESSING METHOD

(71) Applicant: Renesas Electronics Corporation, Tokyo (JP)

(72) Inventors: Masanari NISHIMURA, Tokyo (JP); Saori SATOU, Tokyo (JP); Yo NONOMURA, Tokyo (JP)

(73) Assignee: Renesas Electronics Corporation, Tokyo (JP)

(21) Appl. No.: 15/264,855

(22) Filed: Sep. 14, 2016

(30) Foreign Application Priority Data
Sep. 28, 2015 (JP) 2015-189788

(51) Int. Cl. G06F 9/45

(52) U.S. Cl. CPC G06F 8/42

(57) ABSTRACT

There has been a demand for a technology capable of more efficiently arranging each variable used within a program because the storage capacity of a memory area is limited. A programming language processing program oriented to a microcomputer having a plurality of memory areas is provided. Based on a source program or an object code generated from the source program, information for determining which memory area of the memory areas the variable used within the source program should be arranged in is outputted as arrangement determination information. As to each aggregate variable used within the source program, the arrangement determination information includes information for each element of the corresponding aggregate variable.

### CROSS-REFERENCE TO RELATED APPLICATIONS

The disclosure of Japanese Patent Application No. 2015-189788 filed on Sep. 28, 2015 including the specification, drawings and abstract is incorporated herein by reference in its entirety.

### BACKGROUND

The present disclosure relates to a programming language processing program, a programming language processing device, and a programming language processing method oriented to a microcomputer having a plurality of memory areas.

There has been disclosed a microcomputer in which a specific memory area capable of performing data reading/writing and execution of an instruction at high speed is built in addition to a normal memory area for the purpose of improving the execution speed of a program. In Japanese Unexamined Patent Publication Laid-Open No. Hei 09 (1997)-044363 (Patent Document 1), for example, it become unnecessary for a user to execute memory management in such a microcomputer, and thereby a processing method for a language processing program for reducing a required number of man-hour as the user at the generation of a program is disclosed.

“CubeSuite+ V2.00.00 Integrated Development Environment User's Manual: RL78,78KOR, Build-Edited Rev.1.00” (Non-Patent Document 1) has disclosed that there is provided as a memory area of a microcomputer, an area (saddr area) capable of specifying an address called short direct addressing (saddr addressing) in 8 bits (refer to, for example, page 696 of Non-Patent Document 1). There has been provided a dedicated instruction to refer to the saddr area. This dedicated instruction has the property that an instruction length (size) thereof is smaller by 1 byte than that of an instruction for referring to a normal memory area. Using such a dedicated instruction reduces the size of a user program and thereby enables the cost of a user system to be reduced.

### RELATED ART DOCUMENTS

### Patent Document

[Patent Document 1] Japanese Unexamined Patent Publication Laid-Open No. Hei 09 (1997)-044363

### Non-Patent Document

[Non-Patent Document 1] “CubeSuite+V2.00.00 Integrated Development Environment User's Manual: RL78,78KOR, Build-Edited Rev.1.00”, [online], December 2013, Renesas Electronics Corporation, [Retrieved on Sep. 1, 2015], Internet <URL: http://documentation.renesas.com/doc/products/tool/doc/r20ut2623 jj0100_qsbd78.pdf>

### SUMMARY

Since a general purpose register and a port are also arranged in the saddr area disclosed in Non-Patent Document 1, for example, the storage capacity of an area where a variable/function information file generation tool can arrange data has been defined to be 192 bytes. Thus, there has been a demand for a technology capable of more efficiently arranging each variable used within a program because the storage capacity of the memory area is limited.

Other objects and novel features of the present invention will become apparent from the description of the present specification and the accompanying drawings.

According to one aspect of the present invention, there is provided a programming language processing program oriented to a microcomputer having a plurality of memory areas. From a source program or an object code generated from the source program, information for determining which memory area of the plural memory areas the variable used within the source program is outputted as arrangement determination information. As to each aggregate variable used within the source program, the arrangement determination information includes information for each element of the corresponding aggregate variable.

According to another aspect of the present invention, there is provided a programming language processing program oriented to a microcomputer having a plurality of memory areas. Of each variable other than each aggregate variable used within the source program and each element of each aggregate variable, any to be arranged in a specific memory area of the memory areas is determined, and the aggregate variable including each element determined to be arranged in the specific memory area is scalarized.

According to the one aspect of the present invention, each variable used within a program can be arranged more efficiently.

### BRIEF DESCRIPTION OF THE DRAWINGS

FIG. 1 is a block diagram of a language processing means disclosed in Patent Document 1;

FIG. 2 is atypical diagram showing a functional configuration of the integrated development environment disclosed in Non-Patent Document 1;

FIG. 3 is a diagram showing one example of a source program;

FIG. 4 is a diagram showing one example of a variable/function information file outputted by a linker with respect to the source program shown in FIG. 3;

FIG. 5 is a diagram showing a result of compiling the source program shown in FIG. 3 using the variable/function information file shown in FIG. 4;

FIG. 6 is a conceptual diagram for describing a method of solving a problem in a programming language processing system according to the present embodiment;

FIG. 7 is a conceptual diagram for describing a method of solving a problem in the programming language processing system according to the present embodiment;

FIG. 8 is a typical diagram showing a hardware configuration of a programming language processing device according to an embodiment 1;

FIG. 9 is a typical diagram showing a principal part of a hardware configuration of a microcomputer assumed by the programming language processing system according to the present embodiment;

FIG. 10 is a typical diagram showing a principal part of a hardware configuration of a microcomputer assumed by the programming language processing system according to the present embodiment;

FIG. 11 is a typical diagram showing a principal part of a hardware configuration of a microcomputer assumed by the programming language processing system according to the present embodiment;

FIG. 12 is a typical diagram showing a functional configuration of the programming language processing device according to the embodiment 1;

FIG. 13 is a diagram showing one example of an arrangement determination information file of writing out arrangement determination information thereto;

FIGS. 14A and 14B are diagrams for describing one example of scalarizing in the programming language processing device according to the embodiment 1;

FIG. 15 is a flowchart showing a processing procedure in the programming language processing device according to the embodiment 1;

FIG. 16 is a typical diagram showing a functional configuration of a programming language processing device according to an embodiment 2;

FIG. 17 is a diagram showing one example of an arrangement determination information file of writing out arrangement determination information thereto;

FIG. 18 is a flowchart showing a processing procedure in the programming language processing device according to the embodiment 2;

FIG. 19 is a typical diagram showing a functional configuration of a programming language processing device according to an embodiment 3;

FIG. 20 is a flowchart showing a processing procedure in the programming language processing device according to the embodiment 3; and

FIG. 21 is a typical diagram for describing processing and functions in an integrated development environment according to an embodiment 4.

### DETAILED DESCRIPTION

Preferred embodiments of the present invention will be described in detail while referring to the accompanying drawings. Incidentally, the same or corresponding parts in the drawings are given the same reference numerals respectively, and their description will not be repeated.

### A. Related Technology

First, in order to make clearer the technical significance of a programming language processing system according to the present embodiment, a related technology disclosed in the above-described related art will be described.

(a1: Language Processing Means Disclosed in Patent Document 1)

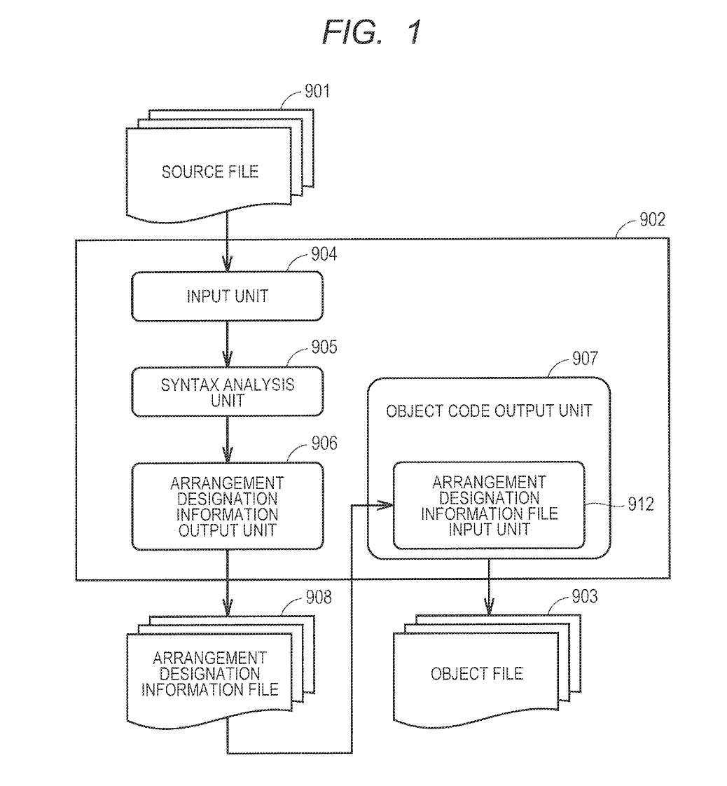

FIG. 1 is a block diagram of the language processing means disclosed in Patent Document 1. The language processing means 902 disclosed in FIG. 1 outputs an object file 903 with a source file 901 described using a programming language as an input. More specifically, the language processing means 902 includes an input unit 904 which accepts the input of the source file 901, a syntax analysis unit 905 which converts a source program described in the source file 901 into an internal representation, an arrangement designation information output unit 906 which outputs an arrangement designation information file 908, and an object code output unit 907 which generates an object file 903. Incidentally, parts related particularly to processing for a variable arrangement to a memory, of the language processing means disclosed in Patent Document 1 are typically illustrated in FIG. 1.

The arrangement designation information output unit 906 extracts each variable to be arranged in a specific memory area, based on the result of syntax analysis by the syntax analysis unit 905 and outputs the result of extraction as the arrangement designation information file 908. The arrangement designation information file 908 is read by an arrangement designation information file input unit 912 included in the object code output unit 907. The object code output unit 907 generates such an object code as to arrange the variable designated in the arrangement designation information file 908 in the specific memory area.

As described above, the language processing means disclosed in Patent Document 1 analyzes the source file 901 to determine a memory arrangement of each variable. The language processing means outputs the contents of the determined memory arrangement as an arrangement designation information file 908 and generates an object file 903, based on the arrangement designation information file 908. With the adoption of such a technology, the object file which utilizes the specific memory area can automatically be generated from the source program described using the general-purpose programming language.

(a2: Integrated Development Environment Disclosed in Non-Patent Document 1)

Non-Patent Document 1 is a manual for the integrated development environment oriented to a microcomputer manufactured and sold by the applicant of the present application and is for describing one application example of the technology disclosed in Patent Document 1.

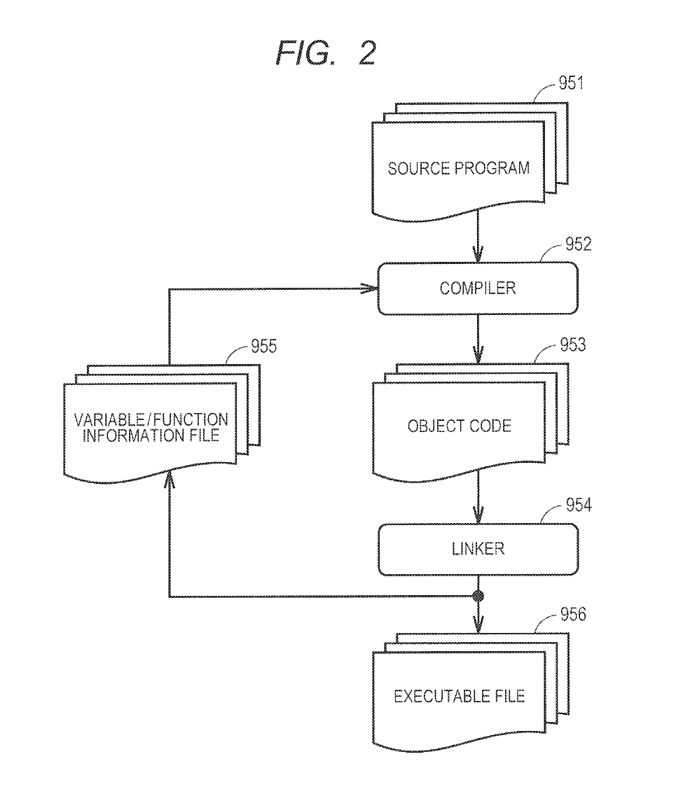

FIG. 2 is a typical diagram showing the functional configuration of the integrated development environment disclosed in Non-Patent Document 1. Referring to FIG. 2, the integrated development environment disclosed in Non-Patent Document 1 eventually outputs an executable file 956 through the conversion to an object code 953 when a source program 951 described using the programming language is inputted. The integrated development environment shown in FIG. 2 includes a compiler 952 and a linker 954. The compiler 952 performs a syntax analysis for the source program 951 to generate an object code 953. The linker 954 sequences variables used within the inputted object code 953 and determines based on this sequence whether the variables can be arranged in saddr areas in respective variable units. The linker 954 outputs information about the variables determined to be arrangeable in the saddr areas as a variable/function information file 955. Thereafter, the source program 951 is inputted again to the compiler 952 together with the variable/function information file 955, so that an object code 953 in which the variables determined to be arrangeable by the liker 954 are arranged in the saddr areas, and an executable file 956 are generated.

(a3: User Program Example of Integrated Development Environment Disclosed in Non-Patent Document 1)

A description will next be made about one example of the user program using the integrated development environment disclosed in Non-Patent Document 1. FIG. 3 is a diagram showing one example of the source program 951. In the source program 951 shown in FIG. 3, five variables c, i, j, l, and s are defined (refer to first to fourth lines).

The variable c defined in the first line is a char type (character type), and the data size thereof is a 1 byte. The variables i and j defined in the second line are respectively an int type (integer type), and the data size of each variable is 2 bytes. The variable l defined in the third line is a long type (double-length integer type), and the data size thereof is 4 bytes. The variable s defined in the fourth line is defined as a struct (structure) and is an aggregate variable of variables a and b each of which is an int type (integer type), and an array c of an int type (integer type) element number 200. As a result, the data size of the variable s becomes 404 bytes (=2+2+2×200).

Further, referring to a reference frequency, the reference frequency of the variable c is once (sixth line), the reference frequency of the variable i is once (seventh line), the reference frequency of the variable j is twice (eighth and ninth lines), the reference frequency of the variable l is twice (eighth line), and the reference frequency of the variable s is four times (eleventh line). Since the variable l is of the long type (double-length integer type) data, two references of high-order and low-order bytes are generated by one use thereof on the source program 951.

Incidentally, the reference frequency does not always match between on the source program 951 and on the object code 953. For example, the value of the variable j described in the eighth line of the source program 951 shown in FIG. 3, and the value of the variable j (added variable) added with 2 which is described in the ninth line are the same. Therefore, on the object code 953, the value of a variable j temporarily stored in an internal register is optimized to be reused without referring to a memory area again in the ninth line after referring to the value of the variable j in its memory area in the eighth line.

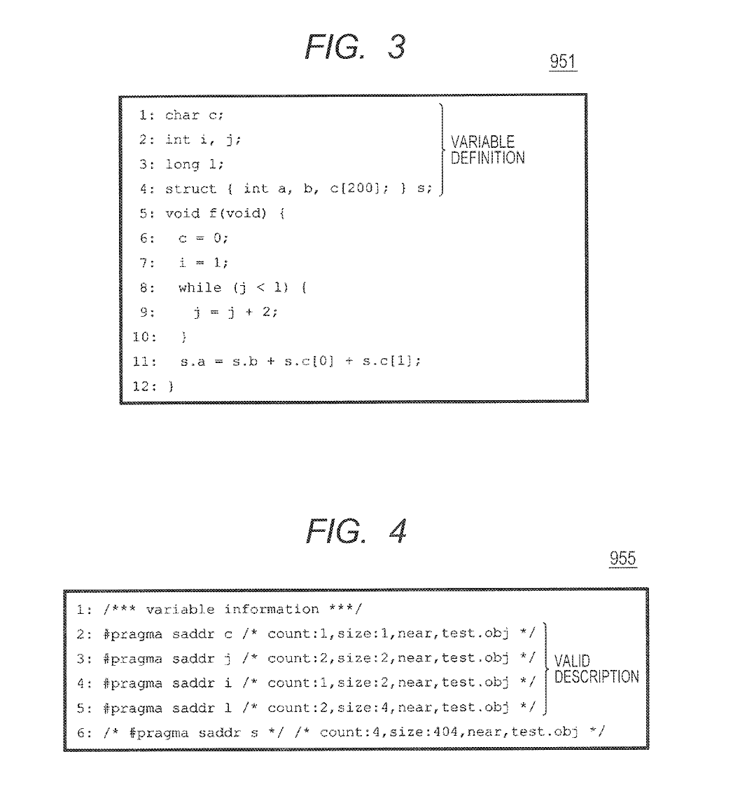

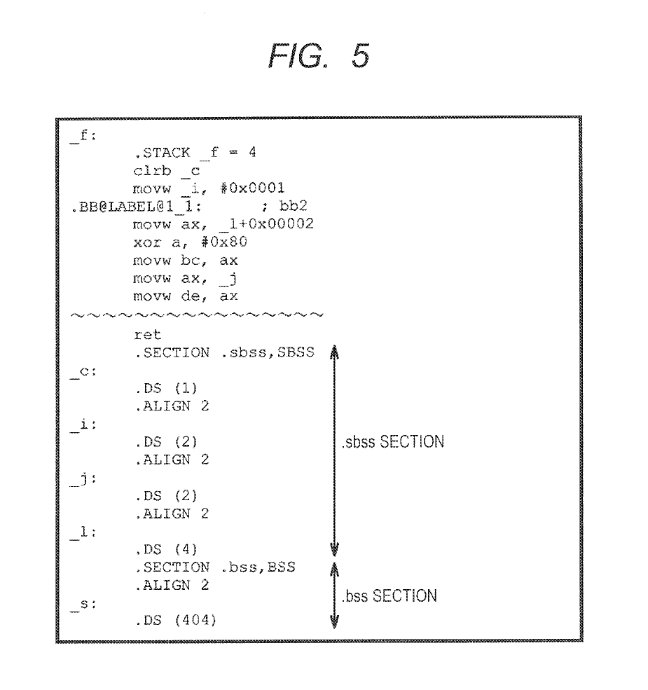

FIG. 4 is a diagram showing one example of the variable/function information file 955 outputted from the linker 954 with respect to the source program 951 shown in FIG. 3.

In the integrated development environment of Non-Patent Document 1, the variables in which the reference frequency per data size is increased are arranged in the saddr areas in order. That is, in the respective variables, the (number of times of reference/data sizes) are calculated as evaluation values, and the evaluation values are arranged in their corresponding saddr areas in descending order.

The pair of “/*” and “*/” included in each line of the variable/function information file 955 shown in FIG. 4 means a comment. A portion beginning with “/*” and ending with “*/” is an invalid description and is not used for processing. Thus, in the above-described variable/function information file 955, only a description of “#pragma saddr (variable symbol name)” placed in each line of the second to fifth lines becomes a valid description. The description of “#pragma saddr (variable symbol name)” is equivalent to an instruction sentence relative to the compiler 952 for arranging a variable of the name shown to the (variable symbol name) in its corresponding saddr area.

Further, “count” included in the comment portions of the second to fifth lines indicates the number of times of reference, and “size” indicates a data size (byte).

According to the description of the variable/function information file 955 shown in FIG. 4, each of the variables c, i, j, and l is arranged in the saddr area, but the variable s is not arranged in the saddr area. This is because when each of the variables c, i, j, and l is arranged in the saddr area (e.g., 192 bytes), a space area enough only to arrange the variable s does not remain in the saddr area.

FIG. 5 is a diagram showing a result of compiling of the source program 951 shown in FIG. 3 by the use of the variable/function information file 955 shown in FIG. 4. According to the compiled result shown in FIG. 5, it is understood that the variables c, i, j, and l are arranged in an saddr area (.sbss section), whereas the variable s is arranged in a normal memory area (.bss section).

### B. Conception of New Problems and Method for Solution Thereof

The applicants of the present application have found out such new problems as shown below from the above-described phenomenon by their intensive studies and led to means to be solved for the new problems. That is, the applicants of the present application have found out the existence of the following problems in the existing integrated development environment.

(b1: Conception of New Problems)

In the integrated development environment disclosed in Non-Patent Document 1, the minimum data unit which determines whether each variable should be arranged in a specific memory area is a variable defined in a source program. Thus, when it is determined whether the variable should be arranged in the specific memory area in the variable unit, such problems (1) and (2) as shown below arise.

(1) An aggregate variable is easy to be estimated with a priority allowing it to be arranged in the specific memory area, which is lower than that for a normal variable (scalar variable).

The scalar variable means a variable indicative of one data and is equivalent to the variables c, i, j, and l defined in the above-described source program 951. The aggregate variable means a variable for collectively handling a plurality of data and is equivalent to the variable s defined in the above-described source program 951. That is, the aggregate variable including a plurality of types of data therein.

As compared with the scalar variable, the aggregate variable is easy to be large in data size and has a deviation in terms of the reference frequency of the included individual data. Therefore, the aggregate variable is easy to become smaller than the scalar variable in terms of the reference frequency (reference frequency/data size) per data size. As a result, the aggregate variable has a tendency that the order in which it should be arranged in the specific memory area is hard to become a high rank.

Individual data included in the aggregate variable are also referred to as elements or members. These will be described as “elements” in the following description. That is, in the present specification, the “elements in the aggregate variable” means the individual data included in the aggregate variable.

When the above-described source program 951 is taken as an example, the reference frequency of each variable is s>j=l>c=i, but the reference frequency per data size becomes c=j>i=l>s. That is, since the data size is large as a whole though the reference frequency itself is large, the reference frequency per data size becomes a small value.

(2) There is a case where the aggregate variable may not be subject to its arrangement in the specific memory area.

Generally, the number of data collected to the aggregate variable depends on the contents of the source program. Further, other aggregate variables can also be included as nests. Therefore, the data size of the aggregate variable may exceed the storage capacity of the specific memory area. The aggregate variable having exceeded the storage capacity of the specific memory area cannot be subject to the arrangement in the specific memory area no matter how many times the reference frequency is increased. When the above-described source program 951 is taken for example, the variable s is 404 bytes in data size originally despite it is referenced four times more than any other variables, and the data size thereof exceeds the storage capacity (e.g., 192 bytes) of the specific memory area. Therefore, the variable s is always arranged in the normal memory area.

(b2: One Method for Solution of Problems)

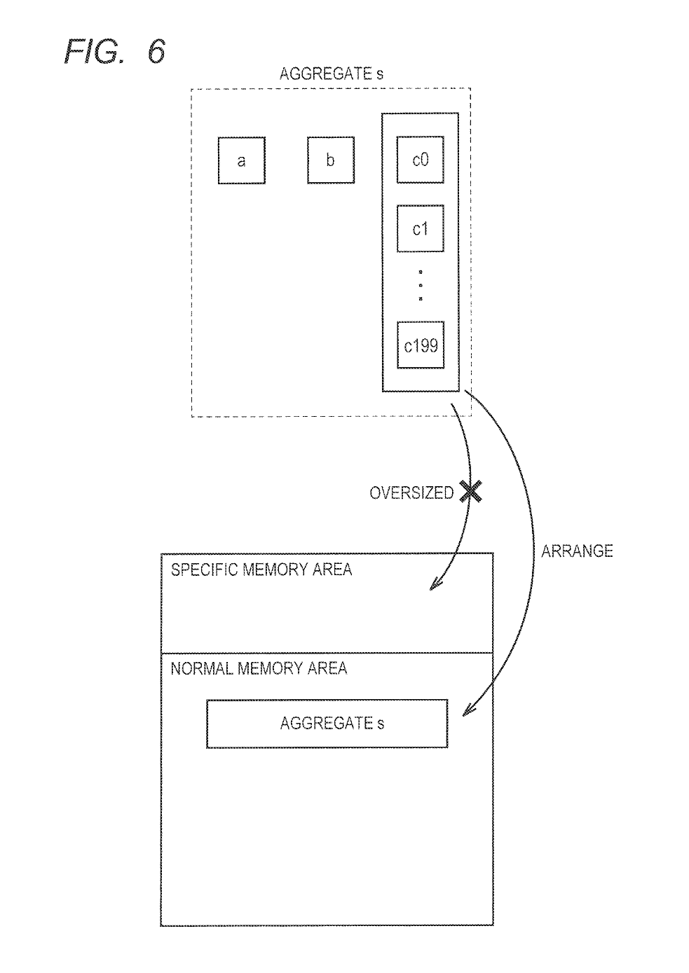

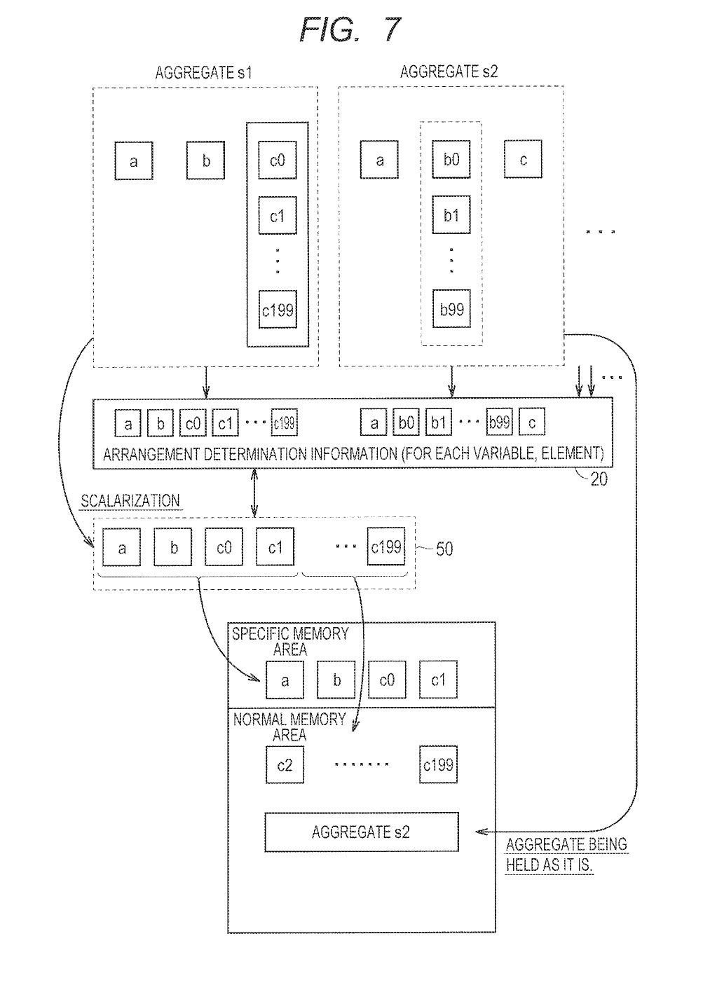

FIGS. 6 and 7 are conceptual diagrams for describing a method for solution of problems in the programming language processing system according to the present embodiment. The programming language processing system according to the present embodiment is oriented to a microcomputer having a plurality of memory areas.

Variable arrangement processing according to the related art is typically shown in FIG. 6. There is a case where when a data size or an evaluation value is calculated as the whole aggregate variable as to a microcomputer to which a plurality of memory areas having characteristics different from each other are mounted, it is not possible to arrange the aggregate variable in a memory area (specific memory area) small in storage capacity. FIG. 6 shows an example in which the entire data size of the aggregate variable exceeds the storage capacity of the specific memory area.

On the other hand, in the programming language processing system according to the present embodiment, which is shown in FIG. 7, arrangement determination information 20 is generated and updated as information necessary to determine an arrangement destination of each variable. The arrangement determination information 20 is information for determining which memory area of the plural memory areas each variable used in a source program should be arranged in.

In the programming language processing system according to the present embodiment, the arrangement determination information 20 is collected from the source program or an object code generated from the source program. The arrangement determination information 20 is typically outputted as a file and can be referred to even from an external application or the like.

The arrangement determination information 20 outputted in the programming language processing system according to the present embodiment is not information already determined in terms of the arrangement destination of each variable, but information necessary to determine whether the variable is arranged from now. In this sense, the arrangement determination information 20 is essentially different from the arrangement designation information file 908 shown in FIG. 1 and the variable/function information file 955 shown in FIG. 2, for designating the arrangement destination of each variable.

In particular, the information is not uniformly stored in variable units, but each aggregate variable is outputted in element units. That is, the information is stored in the arrangement determination information 20 in the element units of each aggregate variable. Using such arrangement determination information 20 enables the arrangement destination of each variable or the like to be optimized in consideration of the information in the element units of the aggregate variable.

The aggregate variables used in the source program may selectively be brought into scalar form, based on the arrangement determination information 20. In the programming language processing system according to the present embodiment, when it is determined that specific elements of the elements included in each aggregate variable should be arranged in the specific memory area, the aggregate variable including the corresponding elements therein is preferentially scalarized. Since the arrangement determination information 20 is generated in both of the scalar variable unit and the element unit, each of the elements included in the aggregate variable is assumed to act as if being another scalar variable, and the propriety of the arrangement thereof in the specific memory area can be determined.

Thus, in the programming language processing system according to the present embodiment, any to be arranged in the specific memory area of the memory areas, of the respective variables other than the aggregate variable used within the source program and the respective elements of the aggregate variable is determined based on the collected arrangement determination information 20. The aggregate variable including each element determined to be arranged in the specific memory area is brought into scalar form. The contents of the information included in the arrangement determination information 20 will be described in detail later.

FIG. 7 shows an example in which an aggregate variable s1 and an aggregate variable s2 are used within a source program. As a result of determination based on the arrangement determination information 20, the aggregate variable s1 is brought into scalar form, and variables a, b, c0, and c1 included therein are determined to be arranged in a specific memory area. On the other hand, the aggregate variable s2 is not scalarized but determined to be arranged in a normal memory area while the aggregate variable remains held as it is.

Selecting the aggregate variable to be scalarized on the basis of the arrangement determination information 20 in this manner makes it possible to improve the execution speed of the program as a whole while suppressing adverse effects by scalarization. A procedure for scalarization and the adverse effects due to scalarization will be described in detail later.

The “aggregates” or “aggregate variable” handled in the programming language processing system according to the present embodiment may include a data aggregate including a plurality of data in addition to a narrow sense used in a specific programming language. That is, in the present specification, if the “aggregates” are capable of handling a plurality of data (elements or members) in a symbolic name, any one may be adopted. The “aggregates” in the present specification may include an “array” and a “union”.

### C. Embodiment 1

A description will next be made about a programming language processing system according to an embodiment 1 of the present invention will next be described.

(c1: Hardware Configuration of Programming Language Processing Device)

A programming language processing device 100 according to the embodiment 1 is typically realized by executing a program by a general purpose computer such as a personal computer. An implementation example of the programming language processing device 100 using the general purpose computer will hereinafter be described.

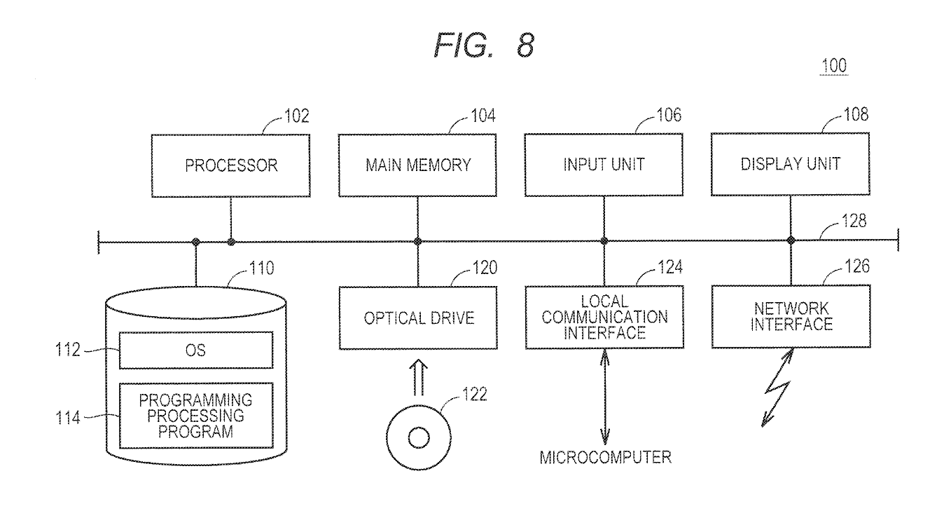

FIG. 8 is a typical diagram showing the hardware configuration of the programming language processing device 100 according to the embodiment 1. Referring to FIG. 8, the programming language processing device 100 includes, as principal components, a processor 102, a main memory 104, an input unit 106, a display unit 108, an auxiliary storage device 110, an optical drive 120, a local communication interface 124, and a network interface 126. These components are configured to enable data communication with each other through a bus 128.

The processor 102 is an arithmetic subject which executes designated instructions in a designated order in accordance with a program. The processor 102 is comprised of, for example, one or plural CPUs (Central Processing Units) or MPUs (Micro Processing Units) or the like. A CPU or an MPU having a plurality of cores may be used.

The main memory 104 functions as a working memory which temporarily stores data or the like necessary for the processor 102 to execute processing in accordance with the program. The main memory 104 is comprised of, for example, a volatile storage device such as a DRAM (Dynamic Random Access Memory).

The input unit 106 is a component which receives a user operation or an instruction from an external device. The input unit 106 is comprised of, for example, a keyboard, a mouse, a touch panel, a pen tablet or the like.

The display unit 108 is a component which notifies a result of information processing by the processor 102 or the like to a user. The display unit 108 is comprised of, for example, a display or various indicators or the like.

The auxiliary storage device 110 is a component which stores therein a program executed by the processor 102, data inputted to an arbitrary program, and data generated by execution of an arbitrary program, etc. The auxiliary storage device 110 is comprised of, for example, a nonvolatile storage device such as a hard disk, an SSD (Solid State Drive) or the like.

An OS (Operating System) 112 and a programming language processing program 114 (hereinafter also abbreviated as a “processing program 114”) are typically stored in the auxiliary storage device 110 of the programming language processing device 100. The OS 112 includes a program module group for providing execution environments of various programs. The processing program 114 includes a program module group for realizing the programming language processing system according to the present embodiment as described later.

The optical drive 120 reads information stored in an optical disk 122 such as a CD-ROM (Compact Disc Read Only Memory), a DVD (Digital Versatile Disc) or the like and outputs the same to other components through the bus 128. The optical disk 122 is an example of a non-transitory recording medium and distributes the processing program 114 or the like in a state of being stored in a non-volatile manner. The optical drive 120 reads the processing program 114 from the optical disk 122 and installs the processing program 114 in the auxiliary storage device 110, so that the personal computer being the general purpose computer functions as the programming language processing device 100. Accordingly, the subject matter of the present invention may also be the processing program 114 itself or the recording medium such as the optical disk 122 with the processing program 114 stored therein.

The local communication interface 124 is a component for communicating with a peripheral device such as a microcomputer. The local communication interface 124 can adopt an arbitrary communication system such as a USB (Universal Serial Bus), a serial bus, a parallel bus, Ethernet (registered trademark), a wireless LAN (Local Area Network), Bluetooth (registered trademark), or the like.

The network interface 126 is a component for exchanging data on Internet or with a server device or the like on Intranet. The network interface 126 can adopt an arbitrary communication system such as Ethernet (registered trademark), the wireless LAN (Local Area Network), Bluetooth (registered trademark) or the like.

Although the optical recording medium such as the optical disk 122 is shown in FIG. 8 as one example of the non-transitory recording medium, the present embodiment is not limited to it. A magnetooptical recording medium such as a semiconductor recording medium such as a flash memory, a hard disk, a magnetic recording medium such as a hard disk or a storage tape, an MO (Magneto-Optical disk), or the like may be used.

The processing program 114 may be not only stored in any recording medium such as described above and distributed, but also downloaded from the server device through Internet or Intranet.

Although FIG. 8 shows, as a typical example, the example in which the processing program 114 for realizing such a programming language processing system as described later is installed, there is no particular limitation as to whether the processing program 114 itself exists in a single body. For example, the processing program 114 may be incorporated as a partial function module of an integrated development environment application. Alternatively, a function equivalent to the processing program 114 may be realized by cooperating a plurality of program modules with each other. Further, part of a functional module necessary for the processing program 114 may be realized using a function or a library provided by the OS 112. In this case, the processing program 114 itself does not include all of the program modules necessary to realize the programming language processing system according to the present embodiment, but can realize the programming language processing system by being installed under an execution environment provided by the OS 112. Even the processing program not including such some program modules may be included in the technical scope of the present invention.

Although there is shown in FIG. 8, the example in which the programming language processing system according to the present embodiment is realized by the programming language processing device 100 alone, the present embodiment is not limited to it. A part or all of processing may be executed by one or plural server devices on the network. Alternatively, the arbitrary data stored in the auxiliary storage device 110 may be stored in one or plural server devices on the network.

Further, all or some of the functions realized by executing the program by the computer (processor 102) may be realized by using a hard-wired circuit such as an integrated circuit. For example, the programming language processing device 100 may be realized by using an ASIC (Application Specific Integrated Circuit). Alternatively, an FPGA (Field-Programmable Gate Array) or the like may be used.

Any person skilled in the art will realize the programming language processing device according to the present embodiment by suitably utilizing the technology corresponding to the times, in which the present invention is carried out.

(c2: Configuration of Microcomputer)

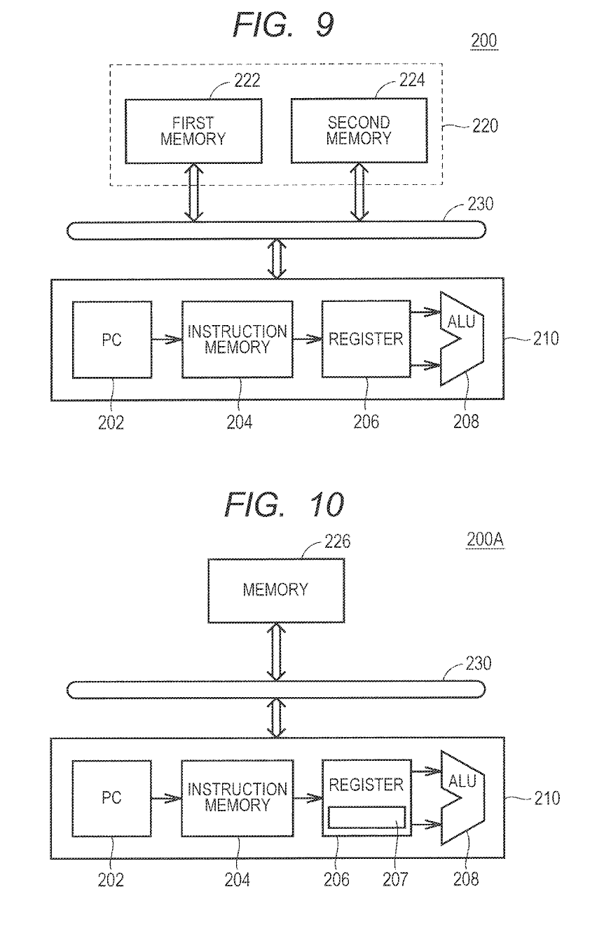

A description will next be made about the configuration of a microcomputer assumed by the programming language processing system according to the present embodiment. In the embodiment 1 and other embodiments, there is assumed a microcomputer having a plurality of memory areas. FIGS. 9 through 11 are typical diagrams respectively showing a principal part of a hardware configuration of a microcomputer assumed by the programming language processing system according to the present embodiment.

Referring to FIG. 9, the microcomputer 200 includes an arithmetic processing section 210, a memory group 220 including a first memory 222 and a second memory 224, and a bus 230 which couples the arithmetic processing section 210 and the memory group 220.

The arithmetic processing section 210 typically includes a program counter (PC) 202, an instruction memory 204, a register 206, and an arithmetic and logic unit (ALU) 208.

The first memory 222 and the second memory 224 have characteristics different from each other. Typically, the first memory 222 has the characteristic of being smaller in storage capacity than the second memory 224, but short in terms of the time required for access. In addition to it, for example, the first memory 222 is given shortened addressing and may be made small in instruction length as compared with an instruction for referring to the second memory 224.

As compared with the microcomputer 200 shown in FIG. 9, the microcomputer 200A shown in FIG. 10 has a memory 226 coupled to a bus 230 as an alternative to the memory group 220, and a special area 207 provided in part of a register 206. Since it is not necessary to perform access to the special area 207 through the bus 230 in the microcomputer 200A, the time required to refer to the special area 207 becomes shorter than the time necessary to refer to the memory 226.

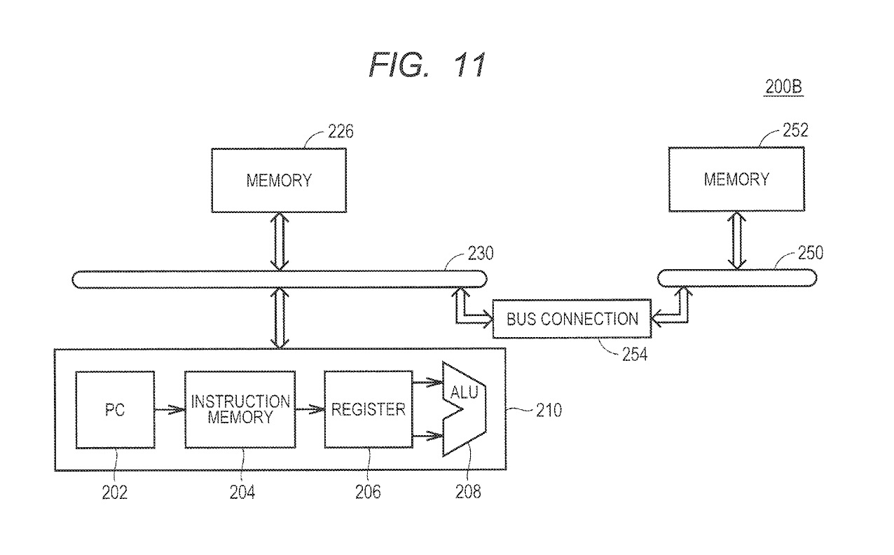

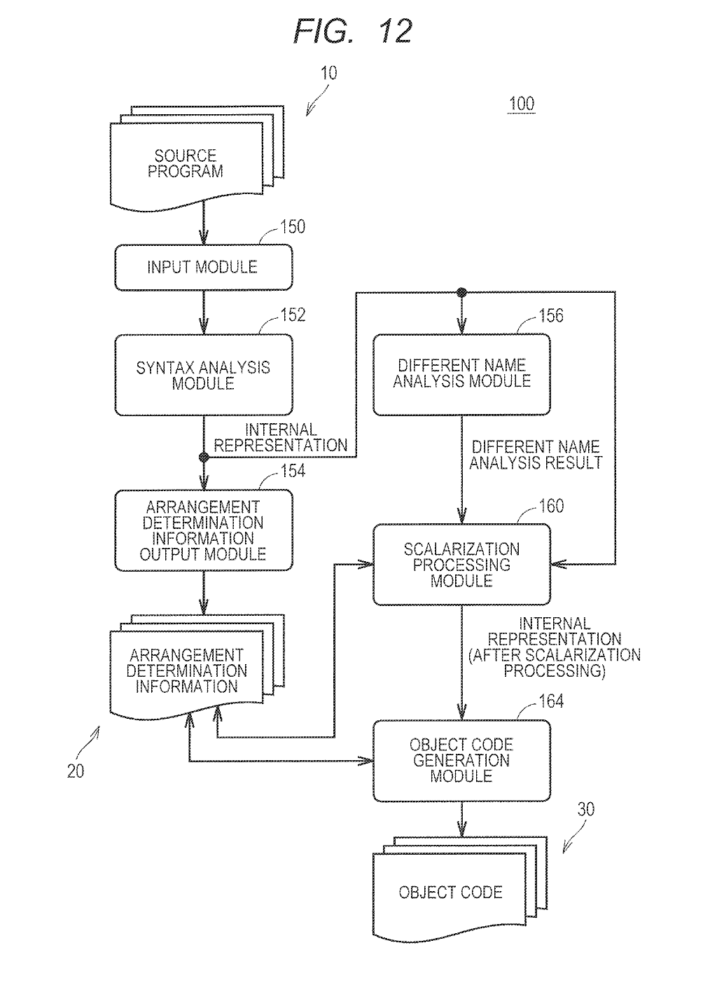

As compared with the microcomputer 200A shown in FIG. 10, the microcomputer 200B shown in FIG. 11 is provided with a memory 252 coupled through a bus connection 254 and a bus 250 instead of the special area 207 provided in part of the register 206. Since an access path to the memory 252 becomes longer than an access path to the memory 226 in the configuration shown in FIG. 11, the time required to refer to the memory 252 becomes longer than the time required to refer to the memory 226. On the other hand, since the memory 252 can be configured independently of the arithmetic processing section 210, the memory 252 having a storage capacity larger than that of the memory 226 can be mounted.

The configurations of the microcomputers shown in FIGS. 9 through 11 are respectively an example, and the microcomputers are not limited to their configurations. The programming language processing system according to the present embodiment is oriented to a method of efficiently arranging data to be referable as variables with respect to the memory areas (not limited to the two types such as shown in FIGS. 9 through 11, and more various kinds of memory areas may be mounted). Typically, variables relatively large in terms of the number of times (frequency) in which they are referred to during execution of a program are arranged in a memory area relatively short in terms of the time necessary for reference. In reverse, variables relatively small in terms of the number of times in which they are referred to during execution of the program are arranged in a memory area relatively long in terms of the time necessary for reference. If the programming language processing system according to the present embodiment has such a configuration that a plurality of candidates can exist as data arrangement destinations, it is not limited to its specific configuration and is widely applicable.

In the following description, the memory area relatively short in terms of the time necessary for reference is referred to as a “specific memory area”, and the memory area relatively long in terms of the time necessary for reference is referred to as a “normal memory area”. Referring to the configuration examples in FIGS. 9 through 11, the “specific memory area” corresponds to the first memory 222 in FIG. 9, the special area 207 in FIG. 10, and the memory 226 in FIG. 11. On the other hand, the “normal memory area” corresponds to the second memory 224 in FIG. 9, the memory 226 in FIG. 10, and the memory 252 in FIG. 11.

In the present embodiment, it is assumed that as a typical example, the “specific memory area” is smaller in storage capacity than the “normal memory area”. The programming language processing system according to the present embodiment is however widely applicable to the microcomputer having the memory areas. The magnitude of the storage capacity between the “specific memory area” and the “normal memory area”, and the length of the time necessary for reference, etc. can arbitrarily be selected.

(c3: Functional Configuration of Programming Language Processing Device)

A description will next be made about the functional configuration of the programming language processing device 100 according to the embodiment 1, and the contents of processing to be executed thereby.

FIG. 12 is a typical diagram showing the functional configuration of the programming language processing device 100 according to the embodiment 1. Referring to FIG. 12, when a source program 10 described using a programming language is inputted, the programming language processing device 100 outputs an object code 30 through a syntax analysis and such processing as to be described later. That is, the programming language processing device 100 functions as a kind of compiler.

More specifically, the programming language processing device 100 includes as its functions, an input module 150, a syntax analysis module 152, an arrangement determination information output module 154, a different name analysis module 156, a scalarization processing module 160, and an object code generation module 164.

The input module 150 receives the input of the source program 10. A user describes processing to be executed on the microcomputer by using the programming language and stores the same in a file, and inputs the same to the programming language processing device 100 corresponding to the programming language processing system. The content of the processing described by the user is the source program 10, and the file having stored the source program 10 therein may also be referred to as a source program file. In order to distinguish from the processing program 114 for realizing the programming language processing system according to the present embodiment, the source program 10 may also be referred to as a “user program”.

The syntax analysis module 152 executes a syntax analysis for the source program 10 that the input module 150 receives. That is, the syntax analysis module 152 converts the source program 10 into an internal representation suitable for the processing in the programming language processing system.

The arrangement determination information output module 154 collects, from the source program 10, information for determining which memory area of a plurality of memory areas variable used within the source program 10 should be arranged in, and output the same as arrangement determination information 20. More specifically, the arrangement determination information output module 154 analyzes the result (internal representation) of the syntax analysis by the syntax analysis module 152 and collects information about the variables included in the source program 10.

The arrangement determination information 20 is a compilation for each variable, of information necessary to determine whether each variable included in the source program 10 should be arranged in a specific memory area. The arrangement determination information output module 154 collects information with respect to the aggregate variable used within the source program 10 according to each element of the corresponding aggregate variable. That is, as to the aggregate variable, information is collected for each element included therein.

The following can be cited as the information included in the arrangement determination information 20.

(1) Reference Frequency

The reference frequency means the total reference frequency in which each variable is referenced upon execution of a program. Since it is possible to shorten the time necessary for memory reference by arranging variables large in the reference frequency in a specific memory area, the execution speed of the program can be improved. Further, when a dedicated instruction small in terms of an instruction length for referring to the specific memory area is provided, the number of times of the dedicated instruction is increased by arranging variables large in the reference frequency in the specific memory area, and the effect of reducing a user program size can be enhanced.

(2) Data Size

A data size means the size of data indicated by each variable. Since the number of variables that can be arranged in a specific memory area can be increased by arranging variables small in data size in a specific memory area, the specific memory area can be utilized more efficiently.

(3) Section to be Referenced

A section to be referenced means which section of a source program each variable is referenced in. Even between variables identical in reference frequency, the arrangement of those referenced concentratedly during a short period in the specific memory area provides less occupation period of the specific memory area. Therefore, the specific memory area can be utilized more efficiently. The section to be referenced can be represented as in the case where, for example, “X to Y lines of a source program are being referenced”.

(4) Side in which Loop is Located (Inside or Outside Loop)

The loop-located side means whether each variable is referenced under a repeatedly-executed loop instruction described in the source program (inside the loop) or referenced by an instruction different from the loop instruction (outside the loop). That is, it means that each variable is referenced under the loop instruction. Generally, since the loop instruction is repeatedly executed many times, it is considered that each instruction in the loop is executed in larger numbers than each instruction outside the loop. Therefore, the number of times in which the specific memory area other than the normal memory area is referenced is increased upon program execution by arranging each variable referenced at a higher frequency within the loop in the specific memory area, so that a higher-speed program execution can be expected.

One example of the arrangement determination information 20 is shown below:

TABLE 1

| | | | | | Reference |
|---|---|---|---|---|---|
| Variable | | | | | frequency |
| symbolic | Reference | | | | (outside |
| name | frequency | Size | Start line | Finish line | loop) |
| c | 1 | 1 | 6 | 6 | 0 |
| i | 1 | 2 | 7 | 7 | 0 |
| j | 2 | 2 | 8 | 9 | 2 |
| l | 2 | 4 | 8 | 8 | 2 |
| s.a | 1 | 2 | 11 | 11 | 0 |
| s.b | 1 | 2 | 11 | 11 | 0 |
| s.c[0] | 1 | 2 | 11 | 11 | 0 |
| s.c[1] | 1 | 2 | 11 | 11 | 0 |
| . . . | | | | | |

Incidentally, the information included in the above-described arrangement determination information 20 is one example. It is not necessary to always include all information therein. For example, it is enough even to include at least one of the above-described kinds in the arrangement determination information 20. Necessary information is appropriately selected according to an architecture of a targeted microcomputer or a language system of a programming language, or the like.

The arrangement determination information output module 154 is also capable of internally delivering the generated arrangement determination information 20 to the scalarization processing module 160. It is, however, also possible to write the arrangement determination information 20 to a file and output it to the outside of the programming language processing system.

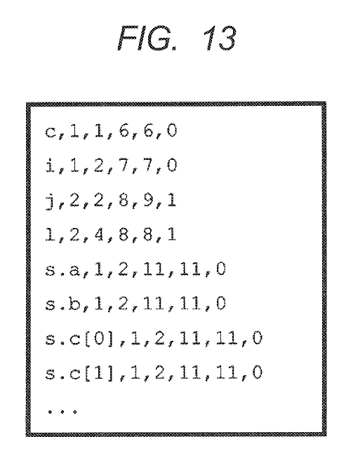

FIG. 13 is a diagram showing one example of an arrangement determination information file to which the arrangement determination information 20 is written out. In the arrangement determination information file shown in FIG. 13, the arrangement determination information 20 is represented in a CSV (Comma Separated Values) format, but is not limited to it. Any data format or any file format may be taken in the form in which necessary information can be represented without lacking.

The different name analysis module 156 specifies an unscalarizable aggregate variable of aggregate variables. When referring means other than the symbolic name of each variable included in the source program 10 exists with respect to the variable, it is referred to as a “different name”. For example, when an arrangement address of a given variable v is stored in a pointer variable p, the variable v can be referenced by referring to the address stored in the pointer variable p. The processing of referring to the address indicated by such a pointer variable p is called “reference peeling” or “dereferencing”. In this case, since the variable v can be referenced using the pointer variable p, the pointer variable p becomes the different name of the variable v.

When the different name exists in the aggregate variable or each element thereof, the arrangement and sequence of each element are restricted, and hence its scalarization cannot be performed. That is, when the aggregate variable is scalarized, it is not possible to perform reference to each variable by the different name. The different name analysis module 156 analyzes an aggregate variable which cannot be an object of scalarizing, or information about its elements, and outputs an analysis result thereof (different name analysis result).

Thus, the different name analysis module 156 specifies an aggregate variable designated by a method different in terms of any included element from a method of designating a variable symbolic name of a corresponding aggregate variable, of the aggregate variables used within the source program 10.

The scalarization processing module 160 scalarizes part or all of the aggregate variables included in the internal representation equivalent to the source program, based on the arrangement determination information 20 and the different name analysis result, and outputs the post-scalarization internal representation to the object code generation module 164. The scalarization processing module 160 reflects the information of the scalarized aggregate variables on the arrangement determination information 20.

More specifically, the scalarization processing module 160 calculates, based on the arrangement determination information 20, the degree of each element (scalar variable) other than the aggregate variable and each element of the aggregate variable to be arranged in the specific memory area of the memory areas, or the degree thereof to be arranged in other than the specific memory area of the memory areas. In the present embodiment, the former, i.e., the degree thereof to be arranged in the specific memory area of the memory areas is calculated as an arrangement priority to the specific memory area. The arrangement priority is an index indicative of which variables included in the source program 10 should be arranged in the specific memory area.

However, the degree of the variable to be arranged in other than the specific memory area of the memory areas may be calculated. In this case, the smaller the calculated degree, the higher the priority in which the variable is arranged in the specific memory area.

The arrangement priority is calculated based on the information included in the arrangement determination information 20. While a plurality of kinds of information are included in the arrangement determination information 20, the type of information used in calculation, weights applied to each information, and calculation expressions, etc. are appropriately determined in such a manner that the arrangement priority is calculated to be high as each variable large in terms of the effect of arranging the same in the specific memory area is taken.

For example, a value obtained by dividing the reference frequency by a data size may be used as the arrangement priority with respect to each variable. Owing to the use of such an arrangement priority, the larger in the reference frequency the variable is, the higher the arrangement priority is calculated. Further, the larger in data size the variable is, the lower the arrangement priority is calculated. That is, the larger in reference frequency the variable is, the more it is preferentially arranged in the specific memory area. Further, as variables large in data size are taken, they become hard to be arranged in the specific memory area because more various kinds of variables are arranged.

An arrangement priority added with the execution performance of a program can also be calculated by assuming the reference in the loop to be plural times.

The aggregate variable can be scalarized from the result of the different-name analysis by the different name analysis module 156. Further, when it is determined that there is a merit enough for its scalarizing, the arrangement to the specific memory area is determined for each element.

After the calculation of the arrangement priority, the scalarization processing module 160 temporarily arranges variables in the order in which the specific memory area can be utilized, in order from the variables higher in arrangement priority. The scalarization processing module 160 may temporarily arrange corresponding variables in the specific memory area in accordance with the decreasing order of the arrangement priority. In reverse, the scalarization processing module 160 may temporarily arrange corresponding variables in the normal memory area in accordance with the increasing order of the arrangement priority. The scalarization processing module 160 repeats such a temporary arrangement until the variables arrangeable in the specific memory area disappear or space disappears in the specific memory area. The temporary arrangement of the variables based on such arrangement priority makes it possible to fill the specific memory area with the variables high in arrangement priority.

As described above, the scalarization processing module 160 determines any to be arranged in the specific memory area, of the respective variables other than the aggregate variable and the respective elements of the aggregate variable, based on at least one of the plural types of information (total number of times that the respective variables are referenced, the size of data indicated by each variable, the section of the source program in which each variable is referenced, and whether or not each variable is referenced under the loop instruction) included in the arrangement determination information 20.

Following the variable temporary arrangement processing, the scalarization processing module 160 scalarizes the aggregate variable of the variables temporarily arranged in the specific memory area assuming that the temporarily arranged variables are all arranged in the specific memory area. That is, when it is determined based on the calculated arrangement priority that each element of any aggregate variable should be arranged in the specific memory area, the scalarization processing module 160 brings the corresponding aggregate variable in the source program 10 into scalarization.

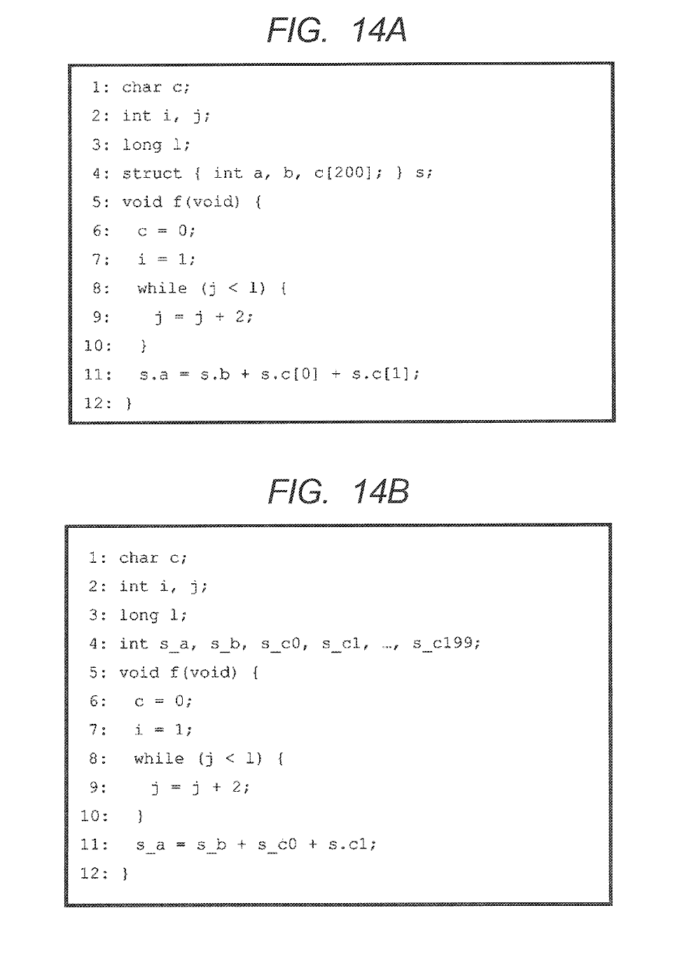

The scalarization processing is processing which decomposes the aggregate variable to a scalar variable independent for each element included therein. FIGS. 14A and 14B are diagrams for describing one example of scalarization in the programming language processing device 100 according to the embodiment 1.

FIG. 14A shows the source program 951 shown in FIG. 3, and FIG. 14B shows a result of scalarization of the source program 951 shown in FIG. 3. It is understood that when FIG. 14A and FIG. 14B are compared, a definition (fourth line) of “struct {int, a, b, c [200];} s;” is converted into a definition (fourth line) of “int s_a, s_b, s_c0, . . . , s_c199;”.

The scalarization processing module 160 scalarizes the aggregate variable including the variables determined to be arranged in the specific memory area. With such scalarization, the specific elements included in the aggregate variable can be arranged in the specific memory area.

However, the scalarization processing module 160 does not scalarize the aggregate variable determined to be unscalarizable by the different name analysis module 156. That is, the scalarization processing module 160 excludes an aggregate variable designated by a method different in terms of elements to be included, from objects for scalarization.

Eventually, the scalarization processing module 160 adds information of a scalar variable generated by scalarizing the aggregate variable to the arrangement determination information 20 and deletes information of the aggregate variable before its scalarization from the arrangement determination information 20. In addition, the scalarization processing module 160 records in the arrangement determination information 20 that the arrangement destinations for all variables temporarily arranged have already been determined.

Incidentally, as the description related to the arrangement destination of each variable, the description similar to the variable/function information file 955 described in FIG. 4 mentioned above can be adopted. For example, of the temporarily arranged variables, the variables not determined to be arranged in the specific memory area eventually may be commented out. It is however unnecessary to output the arrangement destination of each scalarized aggregate variable as an external file or the like. It may be held as internal information and referenced by related processing. Holding the arrangement destination as the internal information makes it possible to avoid complication of compile processing.

The object code generation module 164 generates an object code 30 in a state that the aggregate variable is scalarized. More specifically, the object code generation module 164 generates an object code 30 on the basis of the internal representation after being scalarized by the scalarization processing module 160, and the arrangement determination information 20. The generated object code 30 is outputted as an object code file. More specifically, the object code generation module 164 specifies each variable to be arranged in the specific memory area, based on the arrangement determination information 20 and generates an object code 30 according to its specification.

With the cooperation between the above-mentioned modules, it is possible to achieve the generation of the object code 30 utilizing the specific memory area.

(c4: Processing Procedure)

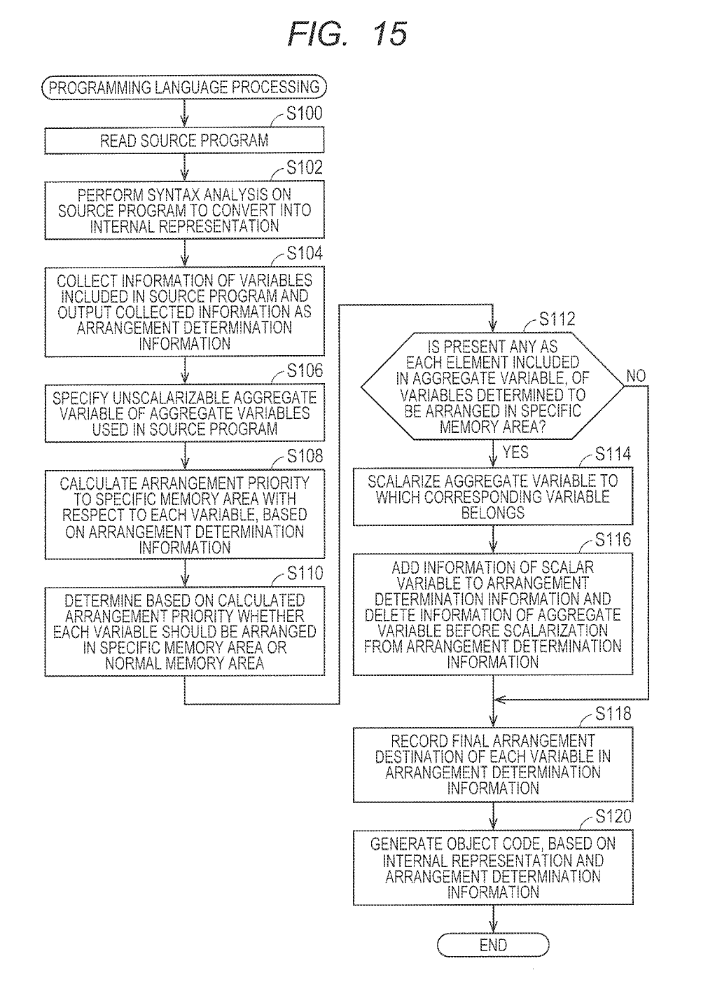

A description will next be made about a processing procedure in the programming language processing device 100 shown in FIG. 12. FIG. 15 is a flowchart showing the processing procedure in the programming language processing device 100 according to the embodiment 1. Each step shown in FIG. 15 is typically realized by allowing the processor 102 to execute the processing program 114 (refer to FIG. 8 in any step).

Referring to FIG. 15, the processor 102 which functions as the input module 150, reads the source program 10 (Step S100). Following this Step, the processor 102 which functions as the syntax analysis module 152, performs a syntax analysis on the read source program 10 and converts it into an internal representation (Step S102). The processor 102 which functions as the arrangement determination information output module 154, analyzes the internal representation converted from the source program 10 to collect information of each variable included in the source program 10 and outputs the collected information as the arrangement determination information 20 (Step S104). That is, the processor 102 collects, from the source program 10, information for determining which memory area of plural memory areas the respective variables used within the source program 10 should be arranged in, and outputs the same as the arrangement determination information 20. At this time, as to each aggregate variable used within the source program 10, information is collected according to each element of the corresponding aggregate variable.

Further, the processor 102 which functions as the different name analysis module 156, analyzes the internal representation converted from the source program 10 and specifies an unscalarizable aggregate variable of the aggregate variables in use (Step S106). That is, the processor 102 specifies out of the aggregate variables used within the source program 10, the aggregate variable which may be designated by a method different in terms of any included element from the method of designating the variable symbolic name of the corresponding aggregate variable. Incidentally, the processing of Step S106 may be executed in parallel with the processing of Step S104 or may be executed before execution of Step S104.

Thereafter, the processor 102 which functions as the scalarization processing module 160, calculates an arrangement priority to the specific memory area with respect to each variable on the basis of the arrangement determination information 20 (Step S108). That is, the degree of each variable other than the aggregate variable and each element of the aggregate variable to be arranged in the specific memory area of the memory areas is calculated based on the arrangement determination information 20.

Following the above, the processor 102 which functions as the scalarization processing module 160, determines that each variable (for each element with respect to data included in each aggregate variable) should be arranged in either the specific memory area or the normal memory area, based on the calculated arrangement priority (Step S110). Then, it is determined whether any as each element included in the aggregate variable, of the variables determined to be arranged in the specific memory area exists (Step S112). When there exists any as each element included in the aggregate variable (YES in Step S112), the processor 102 which functions as the scalarization processing module 160, scalarizes the aggregate variable to which the corresponding variable belongs (Step S114). In Step S106, however, each aggregate variable specified not to be scalarizable is excluded from objects to be scalarized.

In Steps S110 through S114 described above, when it is determined that each element of any aggregate variable should be arranged in the specific memory area, the processor 102 which functions as the scalarization processing module 160, scalarizes the corresponding aggregate variable in the source program 10, based on the calculated arrangement priority.

The processor 102 which functions as the scalarization processing module 160, adds information of a scalar variable generated by scalarizing the aggregate variable to the arrangement determination information 20 and deletes the information of the aggregate variable before its scalarization from the arrangement determination information 20 (Step S116).

When any as each element included in the aggregate variable is not present (NO in Step S112), the processing of Steps S114 and S116 is skipped.

The processor 102 which functions as the scalarization processing module 160, records the final arrangement destination of each variable in the arrangement determination information 20 (Step S118). The processor 102 which functions as the object code generation module 164, generates an object code in a state in which the aggregate variable is scalarized. More specifically, the processor 102 which functions as the object code generation module 164, generates an object code 30, based on the internal representation (internal representation after scalarization processing where the scalarization processing is being executed in Step S114), and the arrangement determination information 20 (Step S120).

By the above-described processing, the object code 30 is generated from the source program 10 after optimizing the arrangement destination of each variable.

(c5: Advantages)

In the programming language processing system according to the present embodiment, each variable to be arranged in the specific memory area is determined after generating or updating the arrangement determination information as to each element included in the aggregate variable. Only when the determined variable is the element of each aggregate variable, the corresponding aggregate variable is scalarized. That is, the aggregate variable targeted for scalarization is determined after generating or updating the arrangement determination information without scalarizing in advance all of the aggregate variables used within the source program.

On the other hand, when all the aggregate variables are scalarized, a harmful effect may arise from another aspect. For example, some of scalar variables derived from elements included in an aggregate variable are arranged in a specific memory area, but the remaining scalar variables are targeted for register allocation as with other variables. Generally, since the number of registers is limited to the specific memory area or more, the registers may also become insufficient. Further, since the scalar variables derived from the elements included in the aggregate variable are hardly referenced and hence the existence of such scalar variables can lead even to the pressure of a register resource.

On the other hand, the above-mentioned selective scalarization enables an improvement in the execution speed of the program while suppressing the harmful effect of the scalarization.

### D. Embodiment 2

While the embodiment 1 described above has shown as an example, the configuration of performing the scalarization processing on the source program 10 to generate the object code, an embodiment 2 will be illustrated with respect to a configuration in which scalarization processing is optimized from a temporarily generated object code.

Since a programing language processing device 100A according to the embodiment 2 is similar to the programming language processing device 100 according to the embodiment 1 except for such a functional configuration as described below, its detailed description will not be repeated.

(d1: Functional Configuration of Programming Language Processing Device)

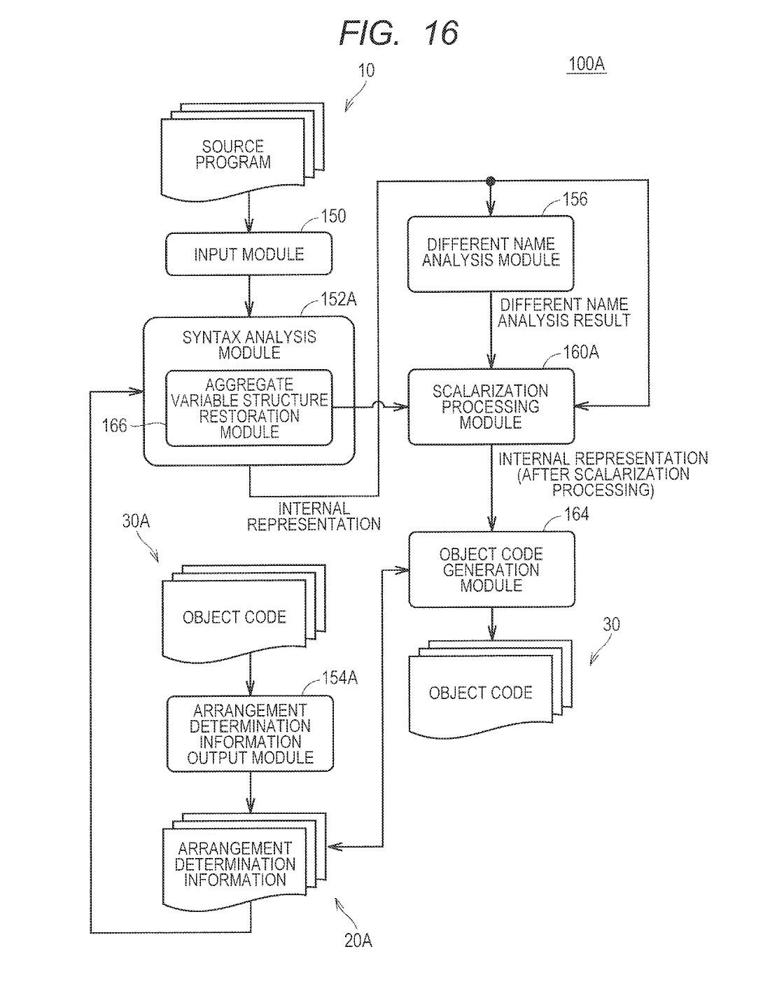

FIG. 16 is a typical diagram showing a functional configuration of the programming language processing device 100A according to the embodiment 2. Referring to FIG. 16, when a source program 10 described using a programming language is inputted, the programming language processing device 100A outputs an object code 30 through a syntax analysis and such processing as described later. More specifically, the programming language processing device 100A includes as its functions, an input module 150, a syntax analysis module 152A, an arrangement determination information output module 154A, a different name analysis module 156, a scalarization processing module 160A, and an object code generation module 164. Since the modules designated at the same reference numerals as those at the modules shown in FIG. 12 are substantially identical in function to their corresponding modules in the programming language processing device 100 according to the embodiment 1, their detailed description will not be repeated.

In the programming language processing device 100A according to the embodiment 2, the arrangement determination information output module 154A is arranged independently of a programming language processing system. That is, in the embodiment 2 unlike the embodiment 1, an object code 30A generated in advance from the same source program 10 is inputted to the arrangement determination information output module 154A.

The arrangement determination information output module 154A receives the input of the object code 30A generated from the source program 10. Then, the arrangement determination information output module 154A collects from the object code 30A, information for determining the area of the plural memory areas where each variable used within the source program 10 should be arranged, and outputs the same as arrangement determination information 20A. More specifically, the arrangement determination information output module 154A refers to the object code 30A and collects information about variables actually referenced on the object code.

The object code 30A is typically generated by the programming language processing device 100 according to the embodiment 1, but not limited to such generation. The object code 30A may be generated using a normal compiler.

The scalarization processing module 160A preferentially scalarizes some aggregate variables, based on the arrangement determination information 20A updated by the arrangement determination information output module 154A. That is, when it is determined that each element of any aggregate variable should be arranged in a specific memory area, based on an arrangement priority calculated from the arrangement determination information 20A, the scalarization processing module 160A scalarizes the corresponding aggregate variable in the source program 10.

The object code generation module 164 generates an object code 30 in a state that the aggregate variable is scalarized. At this time, the object code generation module 164 determines each variable to be arranged in the specific memory area, based on the arrangement determination information 20A and generates an object code 30 corresponding to it.

Thus, one of points of difference between the embodiment 2 and the embodiment 1 resides in that the arrangement determination information 20A is generated from the existing object code 30A. By generating the arrangement determination information 20A on the basis of the object code 30A, each variable determined to be unnecessary after scalarization processing by the scalarization processing module 160A can be excluded from objects to be arranged in the specific memory area. That is, in processing subsequent to the scalarization processing by the scalarization processing module 160A, there is also a case in which it is determined that there is no need to arrange each variable in the specific memory area. In the above-described embodiment 1, there is also a case where since re-scalarization processing is not executed once the object code 30 is generated, the specific memory area is not available efficiently. On the other hand, in the programming language processing device 100A according to the embodiment 2, since each variable targeted for scalarization processing can be reviewed while reflecting a result after the scalarization processing, the specific memory area can be utilized more efficiently.

Another point of difference between the embodiment 2 and the embodiment 1 resides in that the syntax analysis module 152A has an aggregate variable structure restoration module 166. The aggregate variable structure restoration module 166 feeds back each aggregate variable included in the object code as an internal representation. For example, in the object code, the element in the aggregate variable is stored in the form of “variable symbol (head address)+offset”. In order to feed it back as the internal representation, there is a need to restore the structure of the aggregate variable to the form of being available in the internal representation.

The aggregate variable structure restoration module 166 restores the structure of the aggregate variable by comparing the source program 10 and the arrangement determination information 20A. Therefore, the structure thereof is restored not in a stage in which the arrangement determination information 20A is eventually outputted as an arrangement determination information file, but in a stage before its output. Due to the difference in such processing, the arrangement determination information 20A different in format from the arrangement determination information 20 used in the embodiment 1 is used in the embodiment 2.

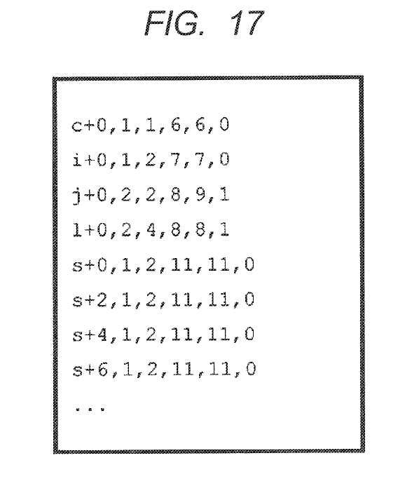

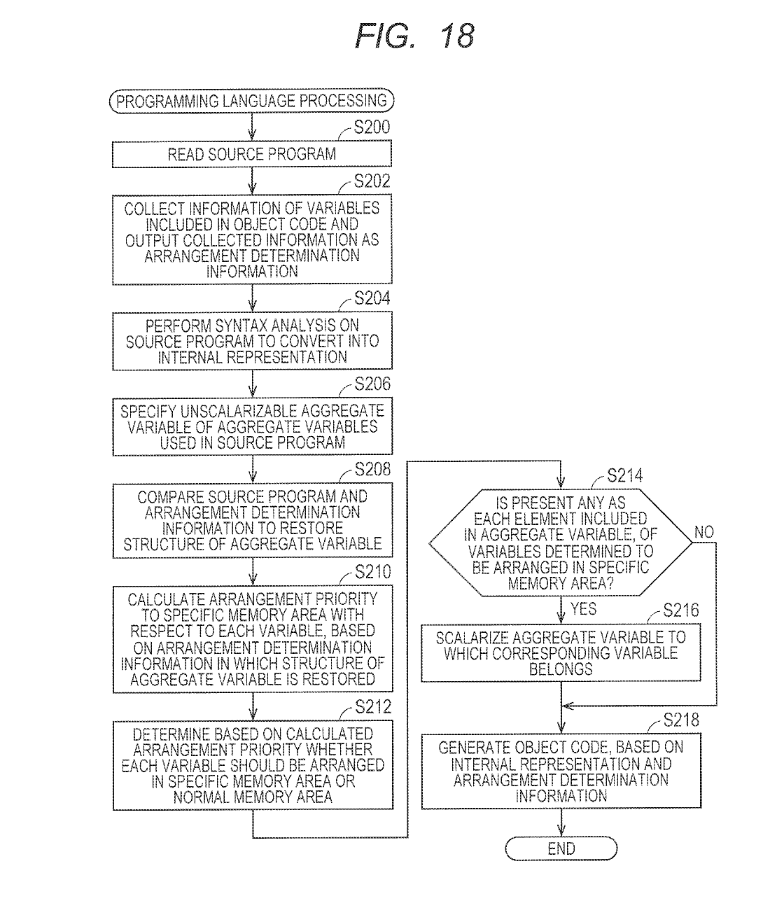

FIG. 17 is a diagram showing one example of the arrangement determination information file to which the arrangement determination information 20A is written out. In the arrangement determination information file shown in FIG. 17, the notation of “aggregate variable symbolic name+offset name” other than the name of each element is adopted to specify each element in the aggregate variable. For example, since the offset becomes 0 because an element a (fifth line) is a first element of a variable s, the element a is notated as “s+0”. Likewise, since an element b (sixth line) is a second element of a variable s and follows the element a (2 bytes), the element b is notated as “s+2”.

Further, since an element s. c is an array, offsets of respective elements in arrays are postposed in addition to an offset 4 of the element s. c itself, and the elements are notated as “s+4”, “s+6”, . . . .

Thus, in the arrangement determination information 20A outputted from the object code 30A, each element of the aggregate variable used within the source program 10 is specified using a combination of a symbolic name of the aggregate variable and one or plural offset values.

(d2: Processing Procedure of Programming Language Processing Device)

A description will next be made about a processing procedure in the programming language processing device 100A shown in FIG. 16. FIG. 18 is a flowchart showing the processing procedure in the programming language processing device 100A according to the embodiment 2. Each step shown in FIG. 18 is typically realized by allowing the processor 102 to execute the processing program 114 (refer to FIG. 8 in any step). Incidentally, a detailed description about processing similar to the processing described in FIG. 15 will not be repeated.

Referring to FIG. 18, the processor 102 which functions as the input module 150, reads a source program 10 (Step S200). In addition, the processor 102 which functions as the arrangement determination information output module 154A, reads an object code 30A generated in advance from the source program 10, analyzes the read object code 30A, collects information about variables included in the object code 30A, and outputs the collected information as arrangement determination information 20A (Step S202). Incidentally, the object code 30A may be generated in accordance with the processing or the like described in the above-described embodiment 1. The processing of Step S202 may be executed in parallel with the processing of Step S200 or may be executed before the execution of Step S200.

The processor 102 which functions as the arrangement determination information output module 154A, collects from the object code 30A, information for determining which memory area of the plural memory areas each variable used within the source program 10 should be arranged in, and outputs the same as arrangement determination information 20A. At this time, as to each aggregate variable used within the source program 10, information is collected according to each element of the corresponding aggregate variable.

The processor 102 which functions as the syntax analysis module 152, performs a syntax analysis on the read source program 10 and converts it into an internal representation (Step S204). The processor 102 which functions as the different name analysis module 156, analyzes the internal representation converted from the source program 10 to thereby specify an unscalarizable aggregate variable of the used aggregate variables (Step S206).

Further, the processor 102 which functions as the aggregate variable structure restoration module 166, restores the structure of the aggregate variable included in the arrangement determination information 20A by comparing the source program 10 read in Step S200 and the arrangement determination information 20A outputted in Step S202 (Step S208). The processing of Step S208 may be executed in parallel with the processing of Steps S204 and S206, or may be executed before the execution of Steps S204 and S206.

The processor 102 which functions as the scalarization processing module 160A, calculates an arrangement priority to the specific memory area with respect to each variable on the basis of the arrangement determination information 20A in which the structure of the aggregate variable is restored (Step S210).

Following the above, the processor 102 which functions as the scalarization processing module 160A, determines that each variable (for each element with respect to data included in each aggregate variable) should be arranged in either the specific memory area or the normal memory area, based on the calculated arrangement priority (Step S212). It is determined whether any as each element included in the aggregate variable, of the variables determined to be arranged in the specific memory area exists (Step S214). When there exists any as each element included in the aggregate variable (YES in Step S214), the processor 102 which functions as the scalarization processing module 160A, scalarizes the aggregate variable to which the corresponding variable belongs (Step S216). In Step S206, however, each aggregate variable specified to be unscalarizable is excluded from objects to be scalarized.

When any as each element included in the aggregate variable does not exist (NO in Step S214), the processing of Step S216 is skipped.

Eventually, the processor 102 which functions as the object code generation module 164, generates an object code in a state in which the aggregate variable is scalarized. More specifically, the processor 102 which functions as the object code generation module 164, generates an object code 30, based on the internal representation (internal representation after scalarization processing where the scalarization processing is being executed in Step S216), and the arrangement determination information 20A (Step S218).

By the above-described processing, the object code 30 is generated from the source program 10 after optimizing the arrangement destination of each variable while referring to the object code 30A.

(d3: Advantages)

In the embodiment 2, the information of each variable is collected from the object code 30A and outputted as the arrangement determination information. The use of the object code 30A enables a final result other than a halfway result of compiling to be assumed as a collection source of arrangement determination information, thereby making it possible to exclude useless information. It is therefore possible to more efficiently perform the arrangement of each variable, based on higher precise arrangement determination information.

Further, even in the arrangement determination information, each element of the aggregate variable is specified using the combination of the symbolic name of the aggregate variable and one or plural offset values, depending on the designating method of each variable by the object code 30A. However, even such arrangement determination information can be fed back to the internal representation by restoring the structure of the aggregate variable. Therefore, even when the arrangement determination information file is processed by an external application, it is possible to easily realize its coping.

### E. Embodiment 3

While the configuration of optimizing the scalarization processing from the temporarily-generated object code has been illustrated in the above-described embodiment 2, an embodiment 3 will be illustrated with respect to a configuration in which information when an executable file generated from an object is actually executed is fed back.

Since a programming language processing device 100B according to the embodiment 3 is similar to the programming language processing device 100 according to the embodiment 1 except for such a functional configuration as described below, a detailed description thereof will not be repeated.

(e1: Functional Configuration of Programming Language Processing Device)

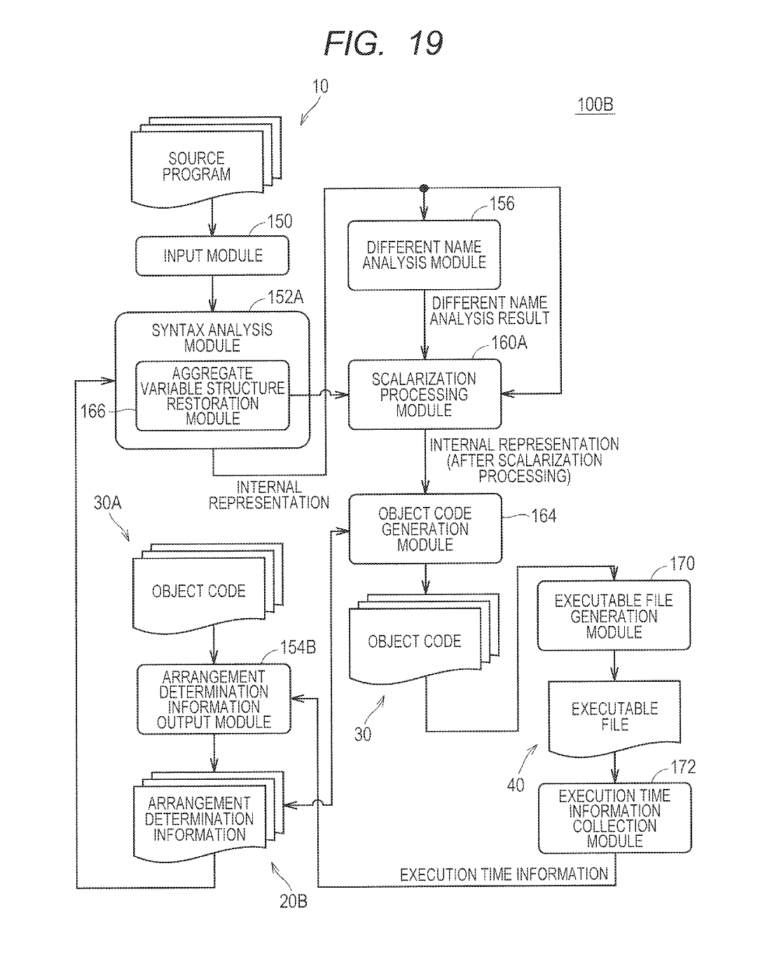

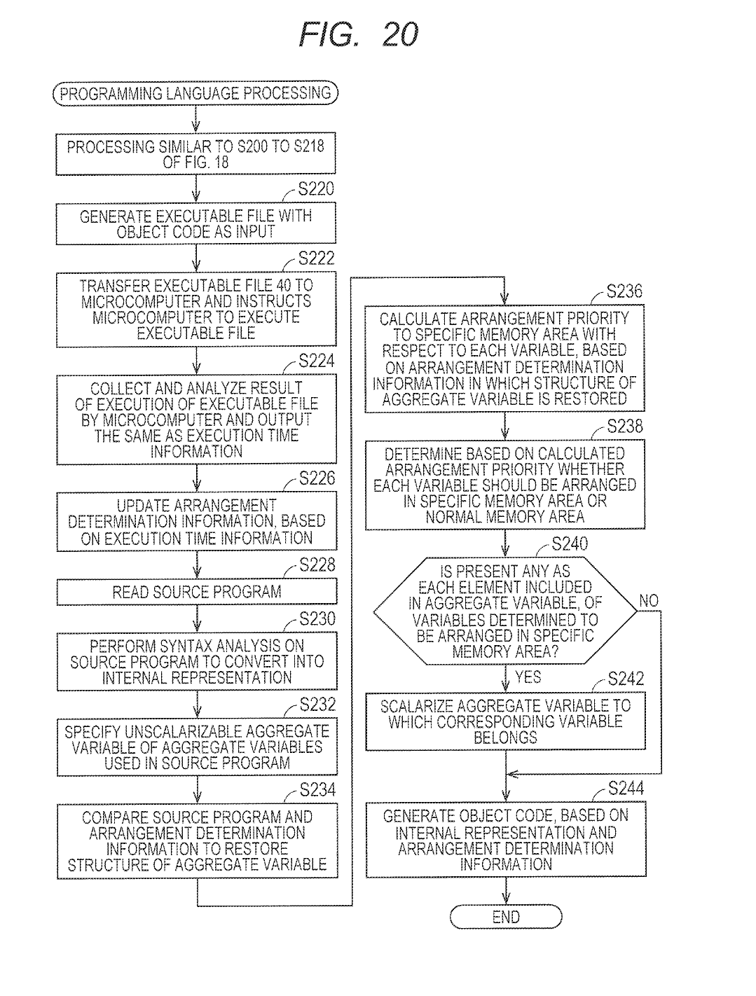

FIG. 19 is a typical diagram showing the functional configuration of the programming language processing device 100B according to the embodiment 3. Referring to FIG. 19, when a source program 10 described using a programming language is inputted, the programming language processing device 100B outputs an object code 30 and an executable file 40 through a syntax analysis and such processing as described later.

In addition to the functional configuration of the programming language processing device 100A shown in FIG. 16, the programming language processing device 100B further includes an executable file generation module 170 and an execution time information collection module 172.

The executable file generation module 170 generates the executable file 40 with the object code 30 as its input. Typically, the executable file generation module 170 can be realized using a linker.

The execution time information collection module 172 collects and analyzes a result of execution of the executable file 40 and outputs the same as execution time information. More specifically, the execution time information collection module 172 can be realized using a profiler and outputs information for reflecting information acquired only at the time of program execution, like an execution frequency and a deviation of input data to the use situation of a specific memory area. The execution time information is outputted to an arrangement determination information output module 154B.

The arrangement determination information output module 154B updates arrangement determination information 20B, based on the input execution time information. A scalarization processing module 160A preferentially scalarizes some aggregate variables, based on the arrangement determination information 20B updated by the arrangement determination information output module 154B. An object code generation module 164 generates an object code 30 in a state in which the aggregate variable is scalarized. At this time, the object code generation module 164 determines a variable to be arranged in the specific memory area, based on the arrangement determination information 20B and generates an object code 30 corresponding to it.

Thus, the use of the execution time information collection module 172 and the arrangement determination information output module 154B enables information at the execution of a user program to be reflected on the arrangement determination information 20B.

(e2: Processing Procedure of Programming Language Processing Device)

A description will next be made about a processing procedure in the programming language processing device 100B shown in FIG. 19. FIG. 20 is a flowchart showing the processing procedure in the programming language processing device 100B according to the embodiment 3. Each step shown in FIG. 20 is typically realized by allowing the processor 102 to execute the processing program 114 (refer to FIG. 8 in any step). Incidentally, a detailed description about processing similar to the processing described in FIG. 15 will not be repeated.

Referring to FIG. 20, processing similar to Steps S200 to S218 in FIG. 18 is executed. Then, the processor 102 which functions as the executable file generation module 170, generates an executable file 40 with an object code 30 as its input (Step S220).

Thereafter, the programming language processing device 100B transfers the executable file 40 to the microcomputer 200 and instructs the microcomputer 200 to execute the executable file 40 (Step S222). The processor 102 which functions as the execution time information collection module 172, collects and analyzes a result of execution of the executable file 40 by the microcomputer 200 and outputs the same as execution time information (Step S224). Incidentally, the result of execution of the executable file 40 may be collected and analyzed using a simulator simulating the operation of the microcomputer 200 instead of its execution by the actual microcomputer 200.

The processor 102 which functions as the arrangement determination information output module 154B, updates the arrangement determination information 20B, based on the execution time information outputted in Step S224 (Step S226). That is, in Steps S222 through S224, the processor 102 updates the contents of the arrangement determination information 20B, based on the information when the executable file 40 is executed by the microcomputer 200.

Subsequently, the processor 102 which functions as the input module 150, reads a source program 10 (Step S228). The processor 102 which functions as the syntax analysis module 152, performs a syntax analysis on the read source program 10 and converts the same into an internal representation (Step S230). The processor 102 which functions as the different name analysis module 156, analyzes the internal representation converted from the source program 10 and specifies an unscalarizable aggregate variable of aggregate variables being in use (Step S232).

Further, the processor 102 which functions as the aggregate variable structure restoration module 166, compares the source program 10 read in Step S228 and the arrangement determination information 20B updated in Step S226 to thereby restore the structure of the aggregate variable included in the arrangement determination information 20B after its renewal (Step S234).

The processor 102 which functions as the scalarization processing module 160A, calculates an arrangement priority to the specific memory area with respect to each variable on the basis of the arrangement determination information 20B in which the structure of the aggregate variable is restored (Step S236). Following the above, the processor 102 which functions as the scalarization processing module 160A, determines whether or not each variable (for each element with respect to data included in each aggregate variable) should be arranged in either of the specific memory area and the normal memory area, based on the calculated arrangement priority (Step S238). It is determined whether any as each element included in the aggregate variable, of the variables determined to be arranged in the specific memory area exists (Step S240). When any as each element included in the aggregate variable is present (YES in Step S240), the processor 102 which functions as the scalarization processing module 160A, scalarizes the aggregate variable to which the corresponding variable belongs (Step S242). In Step S232, however, each aggregate variable specified to be unscalarizable is excluded from objects to be scalarized.

When any as each element included in the aggregate variable is not present (NO in Step S240), the processing of Step S242 is skipped.

Eventually, the processor 102 which functions as the object code generation module 164, generates an object code in a state in which the aggregate variable is scalarized. More specifically, the processor 102 which functions as the object code generation module 164, generates an object code 30, based on the internal representation (internal representation after scalarization processing where the scalarization processing is being executed in Step S242), and the arrangement determination information 20B (Step S244).

As described above, any to be arranged in the specific memory area, of each variable other than each aggregate variable and each element of the aggregate variable is updated from the previously generated object, based on the information when the executable file 40 is executed by the microcomputer 200. With such processing, the object code 30 can be generated from the source program 10 by referring to the result of execution of the executable file 40 after optimizing the arrangement destination of each variable.

(e3: Advantages)

In the embodiment 3, the arrangement destination of each variable can be optimized while reflecting the result of execution of the executable file 40 by the microcomputer 200 (e.g., a profiling result obtained by an external tool such as a profiler). It is therefore possible to realize the efficient arrangement of each variable, on which the state of execution in the actual microcomputer 200 is reflected.

### F. Embodiment 4

As described in the above-described embodiments 1 through 3 respectively, the arrangement determination information can be generated or updated based on the contents of the source program, the contents of the object code, and the result of execution of the executable file. The processing related to the generation or renewal of such arrangement determination information may be incorporated so as to be implemented as the integrated development environment. The user program can efficiently be developed by providing such an integrated development environment to the user. One example of the integrated development environment will be described below as an embodiment 4 centering on the processing of the arrangement determination information.

(f1: Functional Configuration)

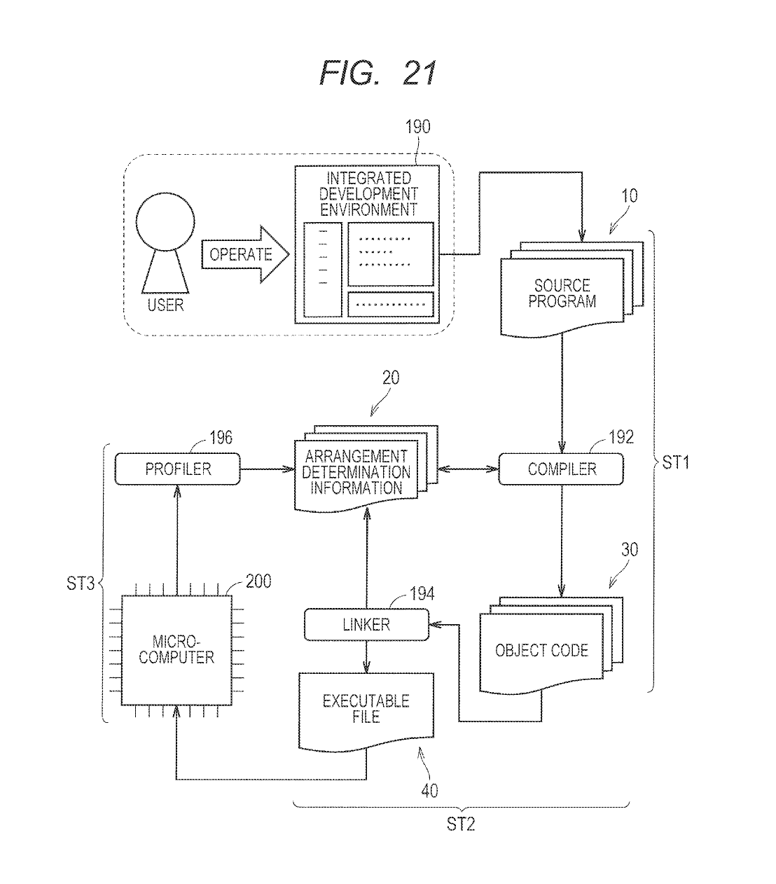

FIG. 21 is a typical diagram for describing processing and functions in an integrated development environment 190 according to the embodiment 4. Referring to FIG. 21, the integrated development environment 190 according to the embodiment 4 is a development environment for a program oriented to a microcomputer having a plurality of memory areas, which includes the programming language processing system according to the present embodiment. The integrated development environment 190 typically includes a compiler 192, a linker 194, and a profiler 196. The integrated development environment 190 may further include an editor and a debugger for generating a source program, etc. The integrated development environment 190 is realized by allowing an application program including a processing program 114 to be installed in and executed by a general purpose computer.

The user generates a source program 10 on the integrated development environment and stores the same as a source program file. By giving instructions from the user on the integrated development environment, the compiler 192, the linker 194, and the profiler 196 respectively execute the following processing:

(1) Generation and Renewal of Arrangement Determination Information 20 Based on Source Program 10 (Stage ST1)

The compiler 192 analyzes the source program 10 to collect information of each variable used within the source program 10 and outputs the same as the arrangement determination information 20. The compiler 192 generates such an object code 30 as to arrange some variables in a specific memory area by referring to the arrangement determination information 20.

(2) Generation and Renewal of Arrangement Determination Information 20 Based on Object Code 30 (Stage ST2)

The linker 194 generates an executable file 40 from the object code 30 inputted thereto. In the process of generating the executable file 40, the linker 194 collects information of each used variable and reflects the same on the arrangement determination information 20. The updated arrangement determination information 20 may be fed back to the compiler 192 to re-regenerate such an object code 30 as to more efficiently arrange some variables in the specific memory area.

(3) Generation and Renewal of Arrangement Determination Information 20 Based on the Result of Execution of Executable File 40 (Stage ST3)

The executable file 40 generated by the linker 194 is written in a program memory of the microcomputer 200 and executed. The profiler 196 collects the result of execution of the executable file 40 and adds execution time information to the arrangement determination information 20. The renewed arrangement determination information 20 may be fed back to the compiler 192 to re-regenerate such an object code 30 as to more efficiently arrange some variables in the specific memory area.

Although the above description has been made about the configuration example in which all of the compiler 192, the linker 194, and the profiler 196 perform the generation and renewal of the arrangement determination information 20, all functions are not necessarily required to be mounted, and only some functions may be implemented.

Since the processing from Stages ST1 through ST3 shown in FIG. 21 are respectively similar to the processing procedures in the programming language processing devices according to the above-described embodiments 1 through 3, their detailed description will not be repeated.

(f2: Advantages)

By providing the above-described integrated development environment according to the embodiment 4, the user program can efficiently be generated without worrying about problems such as whether or not the microcomputer 200 has the specific memory area, how the capacity of the specific memory area is, how each variable can be arranged efficiently, etc.

### G. Other Embodiments

Although the description of the programming language processing system according to the present embodiment described above has been made about the method of determining each variable to be arranged in the memory area (specific memory area) in which the time necessary for reference is relatively short, each variable to be arranged in a memory area in which the time necessary for reference is relatively long may reversely be determined.

Although the above embodiment 3 has been described so as to execute in combination, the optimization of the arrangement destination of each variable using the arrangement determination information acquired from the object code described in the embodiment 2, only the result of execution of the executable file may be reflected.

### H. Summary

According to the programming language processing system according to the present embodiment, the data such as the aggregate variable not capable of being arranged in the specific memory area in the related art can be arranged in the specific memory area. Consequently, the utilization efficiency of the specific memory area is improved, and an increase in the execution speed of the user program and a reduction in code size, etc. can be expected.

Although the invention made above by the present inventors has been described specifically on the basis of the preferred embodiments, the present invention is not limited to the embodiments referred to above. It is needless to say that various changes can be made thereto within the scope not departing from the gist thereof.

What is claimed is:

1. A computer program product comprising a computer readable storage medium having program instructions embodied therewith, the program instructions executable by a computer to cause the computer to perform a method to process a program for microcomputer having a plurality of memory areas, the method comprising:
reading a source program for the microcomputer or an object code generated from the source program; and
collecting from the read source program or object code, information for determining which memory area of the memory areas each variable used within the source program is to be arranged in, and outputting the collected information as arrangement determination information,
wherein the outputting includes collecting, in terms of each aggregate variable used within the source program, information for each element of the corresponding aggregate variable.

2. The computer program product according to claim 1, further comprising:
calculating, based on the arrangement determination information, the degree of each variable other than the aggregate variable and each element of the aggregate variable to be arranged in a specific memory area of the memory areas, or the degree of said each variable and said each element to be arranged in other than the specific memory area of the memory areas; and
when it is determined based on the calculated degree that each element in any aggregate variable is to be arranged in the specific memory area, scalarizing the corresponding aggregate variable in the source program.

3. The computer program product according to claim 2, further comprising:
generating an object code in a state in which the aggregate variable is scalarized.

4. The computer program product according to claim 2, further comprising:
specifying an aggregate variable designated by a method different in terms of any included element from a method of designating a variable symbolic name of the corresponding aggregate variable, of the aggregate variables used within the source program,
wherein the scalarizing includes excluding the aggregate variable designated by the different method from objects to be scalarized.

5. The computer program product according to claim 1, further comprising:
generating an executable file from the object code; and
updating the contents of the arrangement determination information, based on information when the executable file is executed by the microcomputer.

6. The computer program product according to claim 1, wherein the arrangement determination information includes at least one of the total number of times each variable is referenced, the size of data indicated by each variable, a section of the source program in which each variable is referenced, and whether or not each variable is referenced under a loop instruction.

7. The computer program product according to claim 1, wherein the outputting includes, when the object code is read, specifying each element of the aggregate variable used within the source program in the arrangement determination information by using a combination of the symbolic name of the aggregate variable and one or plural offset values.

8. The computer program product according to claim 2, wherein the specific memory area is smaller in storage capacity than other memory areas.

9. A programming language processing device oriented to a microcomputer having a plurality of memory areas, comprising:
an input circuit which receives a source program for the microcomputer or an object code generated from the source program; and
an output circuit which collects from the source program or the object code, information for determining which memory area of the memory areas each variable used within the source program is to be arranged in, and output the same as arrangement determination information,
wherein the output circuit collects in terms of each aggregate variable used within the source program, information for each element of the corresponding aggregate variable.

10. A computer program product comprising a computer readable storage medium having program instructions embodied therewith, the program instructions executable by a computer to cause the computer to perform a method to process a program for microcomputer having a plurality of memory areas, the method comprising:
collecting from a source program for the microcomputer or an object code generated from the source program, information for determining which memory area of the memory areas each variable used within the source program is to be arranged in; and
determining based on the collected information, any to be arranged in a specific memory area of the memory areas, of each variable other than each aggregate variable used within the source program and each element of each aggregate variable, and scalarizing an aggregate variable including the element determined to be arranged in the specific memory area.

11. The computer program product according to claim 10, further comprising:
generating an object code in a state in which the aggregate variable is scalarized.

12. The computer program product according to claim 10, wherein the scalarizing includes calculating, based on the collected information, the degree of each variable other than the aggregate variable and each element of the aggregate variable to be arranged in the specific memory area of the memory areas, or the degree of said each variable and said each element to be arranged in other than the specific memory area of the memory areas.

13. The computer program product according to claim 10, further comprising:
specifying an aggregate variable designated by a method different in terms of any included element from a method of designating a variable symbolic name of the corresponding aggregate variable, of the aggregate variables used within the source program,
wherein the scalarizing includes excluding the aggregate variable designated by the different method from objects to be scalarized.

14. The computer program product according to claim 10, further comprising:
generating an executable file from the object code; and
updating, based on information when the executable file is executed by the microcomputer, any to be arranged in the specific memory area, of each element other than the aggregate variable and each element of the aggregate variable.

15. The computer program product according to claim 10, wherein the scalarizing includes determining, based on at least one of the total number of times each variable is referenced, the size of data indicated by each variable, a section of the source program in which each variable is referenced, and whether or not each variable is referenced under a loop instruction, any to be arranged in the specific memory area, of each variable other than the aggregate variable and each element of the aggregate variable.

16. The computer program product according to claim 10, wherein the specific memory area is smaller in storage capacity than other memory areas.
